(19) United States
(12) Patent Application Publication
(10) Pub. No.: US 2026/0220226 A1
(43) Pub. Date: Jul. 30, 2026

(54) USER CONTROL OF OPERAND SCALING

(71) Applicant: ADVANCED MICRO DEVICES, INC., Santa Clara, CA (US)

(72) Inventors: Stuart David Simpson Biles, Bury St. Edmunds (GB); Michael Estlick, Fort Collins, CO (US); Brian William Thompto, Austin, TX (US); Gabriel H. Loh, Bellevue, WA (US); Eric Mark Schwarz, Fishkill, NY (US); Thomas Winters Fox, Fishkill, NY (US); Marius Evers, Santa Clara, CA (US)

(21) Appl. No.: 19/434,965

(22) Filed: Dec. 29, 2025

Related U.S. Application Data
(60) Provisional application No. 63/751,581, filed on Jan. 30, 2025.

(51) Int. Cl. G06F 17/16

(52) U.S. Cl. CPC G06F 17/16

(57) ABSTRACT

A scale register is configured to store a first set of block scale factors associated with a first input vector to an operation and a second set of block scale factors associated with a second input vector to the operation. A processing unit is configured to perform the operation based on the first input vector, a first scale factor selected from the first set based on user input, the second input vector, and a second scale factor selected from the second set based on the user input. In some cases, the operation is an outer product operation and the processing unit includes a matrix engine configured to perform the outer product. The elements of the first input vector and the second input vector can represent quantized values of elements represented in a first precision that is higher than a second precision of the quantized values.

### BACKGROUND

Machine learning (ML) models, which include artificial intelligence (AI) models and techniques, operate on numerical representations of data such as text, audio, and images. A typical numerical representation is an embedding such as a vector embedding that encodes features of the data in a series (or vector) of numerical values. An ML model is typically represented by a set of matrices or tensors having values that are trained to transform the numerical representation of the input data into one or more output values. Neural networks are often used to implement ML models. A typical neural network includes an input layer, one or more hidden layers, and an output layer formed of interconnected sets of nodes. The nodes are connected so that the output of nodes in one layer becomes the input to nodes in a subsequent layer. As data is passed from one node to the next, the data is multiplied by a weight associated with the connection between the two nodes. The weight therefore represents the strength of the connection between the two nodes. Nodes combine the weighted inputs, typically as a linear combination, to determine a value that is provided to an activation function that determines whether the node should “activate.” The weights and activation functions that represent an ML model are typically represented as floating point numbers in a format such as FP32 (32-bit floating point) or FP16 (16-bit floating point).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that supports user control of operand scaling, according to some embodiments.

FIG. 2 illustrates a logical organization of computational extensions that support user control of operands scaling, according to some embodiments.

FIG. 3 illustrates a set of tile registers and a corresponding block scale register, according to some embodiments.

FIG. 4 illustrates an operation that computes a radix-1 outer product of two input vectors, according to some embodiments.

FIG. 5 illustrates an operation that computes a radix-2 outer product of two input vectors, according to some embodiments.

FIG. 6 illustrates an operation that computes a radix-4 outer product of two input vectors that are scaled by corresponding scale factors, according to some embodiments

FIG. 7 illustrates circuitry configured to perform an outer product operation on scaled input vectors at a tile element, according to some embodiments.

FIG. 8 illustrates a method of user-controlled operand scaling, according to some embodiments.

### DETAILED DESCRIPTION

Outer product operations are frequently performed during training of ML models and inference on the trained ML models. The outer product of two vectors is a matrix of entries that are products of an element in the first vector with an element in the second vector. If the two vectors have dimensions n and m, then their outer product is an n×m matrix. More generally, the outer product of two tensors is a tensor. Elements of the vectors, matrices, or tensors used in ML models are often quantized to reduce the precision of the weights and activation functions, which reduces the memory requirements and computational complexity of the ML model. Reducing the number of bits used to represent values of the model elements also reduces the range of values that can be represented. The quantization process therefore introduces scale factors that allow elements with a large range of values to be represented by a smaller number of bits. Subsets of the elements within portions, or blocks, of a matrix typically use the same or similar scale factors. A single block scale factor can therefore be applied to the elements in a block instead of defining a separate scale factor for each element. For example, a scale factor can be shared across a block of 32 data elements.

Elements of the two vectors that are input to an outer product operation are typically associated with different block scale factors. During multiplication of the vector elements, the two block scale factors for the two elements are combined and used to scale the product of the (scaled) vector elements. A matrix multiplication engine that is performing the outer product operation is therefore required to reference the appropriate block scale factors for the input vectors. To support reuse and prefetching of values of the scale factors, the compute architecture could be modified to add a register file that includes a set of registers for storing each scale factor for each of the vector elements. However, this approach has several disadvantages. The outer product operations would be required to refer to the additional state defined by the register file and this state information would have to be tracked and potentially renamed, which increases the cost and complexity of the associated dependency analysis. The outer product operations would also require instruction set architecture (ISA) encoding space to specify the operands. Furthermore, the dimensions of the scale factor registers would not necessarily match dimensions of the interfaces to related caches or register files, which would negatively impact operation of, and data connections to, the outer product engine.

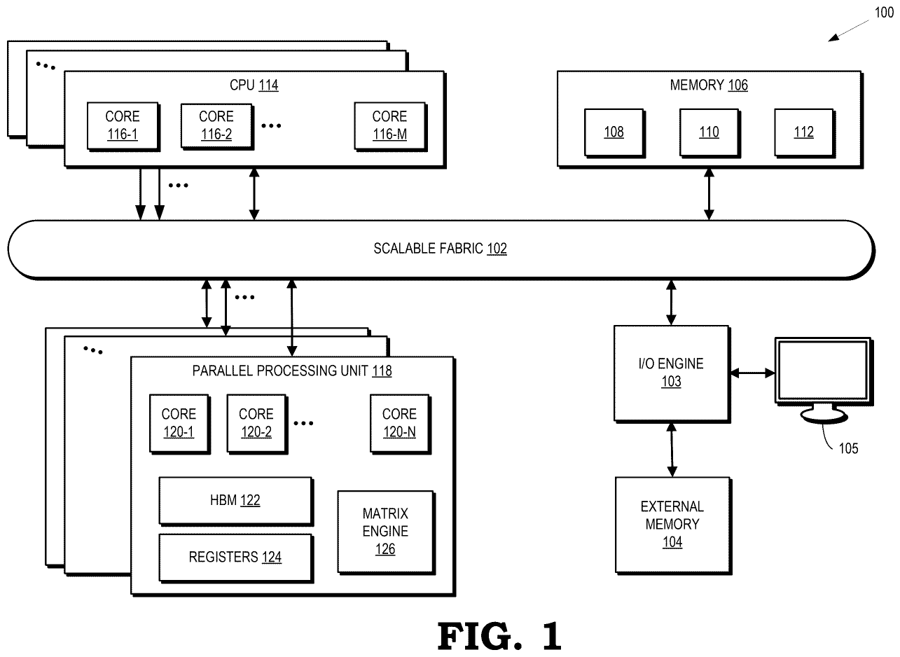

FIGS. 1-8 illustrate methods, apparatuses, and systems of providing and supporting a scale register configured to store block scale factors for first and second input vectors to an outer product operation. The illustrated techniques improve potential data transfer rate and overall performance of a processing system, processing unit, processor, or matrix engine that implements embodiments of the techniques. To support user control of scale factors, a first subset of the bits in the scale register is allocated to store block scale factors for the first input vector and a second subset of the bits in the scale register is allocated to store block scale factors for the second input vector. In some embodiments, the first and second input vectors include N bits that represent quantized values of the vector elements, and the scale register includes 2*N bits that represent scale factors that can be applied to the quantized values in the two input vectors. For example, if the first and second input vectors to a radix-4 outer product are 512-bit vectors including 16 sets of four lanes that each include a value represented by eight bits, the scale register is 1024 bits wide and can be partitioned into eight 128 bit segments. Each of the 128 bit segments includes an eight bit scale factor for one of the 16 lanes that include the (quantized) values of the first or second input vector. Thus, the scale register includes eight options for the scale factor that can be applied to the (quantized) values of the corresponding input vectors. The scale factors in the scale register are selected from the available options and mapped to elements of the first or second input vectors based on a first index that is included in the argument to an outer product operation. The outer product is generated by multiplying (and accumulating in the case of an outer product radix greater than one) the quantized values of the elements in the first and second input vectors and scaling the resulting product based on a combination of the scale factors associated with the quantized values of the elements. The scaled value of the product can then be accumulated with previously computed values for the same tile, which is indicated by the indices of the vector elements.

The first and second input vectors or the outer product operation can be drawn from blocks (e.g., the rows and columns) of a corresponding matrix or tensor. Different sets of scale factors can be applied to different blocks of the matrix. In some embodiments, the architecture provides an instruction to load the values in the scale register based on the blocks of the matrix that provide the first and second input vectors for the outer product operation. The values in the scale register can then be modified to use different scale factors for different blocks of the matrix. For example, a first instruction can be issued to load a first set of scale factors in the scale register for first and second input vectors drawn from a first set of blocks. The outer product operation is then performed on the vectors in the first set of blocks using the first set of scale factors. A second instruction is subsequently issued to load a second set of scale factors in the scale register for a second set of blocks and the outer product operation is performed again. Values in the tiles of the outer product matrix are accumulated over the iterations. In some embodiments, the overhead for loading the modified scale factors is “hidden” by loading the modified scale factors concurrently with computing the outer product based on previously loaded scale factors. The architecture can also include more than one scale register to support preloading or prefetching sets of block scale factors.

The scale factor registers discussed herein support user control of operand scaling, e.g., by supporting a scale specifier instruction that allows flexibility and reuse of scale terms in blocked algorithm implementations. An implicit scale register combined with restriction on opmask encoding provides future flexibility, e.g., to introduce opmask predication (such as nrow/ncol style predication) or to introduce additional architectural block scale register names. Supporting separate and independent specifiers of the scale groups that are to be used for the two (A and B) matrix inputs provides flexibility of using block scale register resources and facilitates blocking algorithm implementation and operand reuse.

FIG. 1 is a block diagram of a processing system 100 that supports user control of operand scaling, according to some embodiments. The processing system 100 includes a scalable fabric 102 implemented with circuitry that supports communication between entities implemented in the processing system 100. The scalable fabric 102 can include a control fabric for conveying control signals and a data fabric for conveying data between entities in the processing system 100. Some implementations of the processing system 100 include other buses, bridges, switches, routers, and the like, which are not shown in FIG. 1 in the interest of clarity. An input/output (I/O) engine 103 is implemented with circuitry that handles input or output operations associated with an external memory 104 and a display 105, as well as other elements of the processing system 100 such as keyboards, mice, printers, speakers, headphones, and the like. The I/O engine 103 is coupled to the scalable fabric 102 so that the I/O engine 103 can communicate with other entities in the processing system 100 by exchanging signals over the scalable fabric 102.

Processing system 100 also includes or has access to a memory 106 or other storage component(s) implemented using non-transitory computer-readable media such as a dynamic random-access memory (DRAM). However, some embodiments of the memory 106 are implemented using other types of memory including, for example, static random-access memory (SRAM), nonvolatile RAM, and the like. Some embodiments of memory 106 include an external memory implemented external to the processing units implemented in the processing system 100. The memory 106 can store information representing instructions such as program code 108 for one or more applications (e.g., graphics applications, compute applications, ML models or applications), data 110 that is consumed by the program code 108, and results 112 produced by executing the program code 108. The memory 106 is also referred to herein as “system memory 106.”

One or more processing units 114 are deployed in the processing system 100, although only one CPU 114 is indicated by a reference numeral in the interest of clarity. In the illustrated embodiment, the processing units 114 are implemented as central processing units (CPUs) but in other embodiments the processing units can be implemented as other devices such as accelerated processing units (APUs) that include an integrated parallel processing unit such as an integrated GPU. The CPU 114 is connected to the scalable fabric 102 to communicate with other entities in the processing system 100, such as the I/O engine 103, the display 105 (or associated display engine), the memory 106, or other entities connected to the scalable fabric 102. The CPU 114 includes circuitry configured to implement a plurality of processor cores 116-1, 116-2, . . . 116-M that execute instructions concurrently or in parallel. Although three processor cores 116 are shown in FIG. 1, more or fewer processor cores 116 can be implemented in other embodiments of the CPU 114. The processor cores 116 include circuitry to implement one or more compute units or elements such as single-instruction, multiple data (SIMD) units that perform the same operation on different data sets to produce one or more results. The CPU 114 is configured to execute instructions such as the program code 108 for one or more applications (e.g., graphics applications, compute applications, machine learning applications), which is stored in the memory 106. The CPU 114 can consume data 110 and store information in memory 106 such as the results 112 of the executed instructions.

The processing system 100 also includes one or more parallel processing units 118, although only one parallel processing unit 118 is indicated by a reference numeral in the interest of clarity. The parallel processing units 118 can include, for example, a GPU, a general-purpose GPU (GPGPU), a neural processing unit (NPU), a tensor processing unit (TPU), an intelligence processing unit (IPU), or other type of vector processor or parallel processor. The parallel processing units 118 include circuitry to implement one or more processor cores 120-1 . . . N that each operate as a compute unit or element configured to perform one or more operations based on one or more instructions received by the parallel processing units 118. The instructions or operations can be performed or executed concurrently by the processor cores 120. Although three processor cores 120 are shown in FIG. 1, more or fewer processor cores 120 can be implemented in other embodiments of the parallel processing unit 118. The compute units or elements in the processor cores 120 are implemented as circuitry for one or more single-instruction, multiple data (SIMD) units that perform the same operation on different data sets to produce one or more results.

In some embodiments, the parallel processing unit 118 includes circuitry for storing data, such as one or more high bandwidth memories (HBM) 122 that are used to store instructions or data that are accessed by one or more of the processor cores 120 via high bandwidth connections (not shown in FIG. 1 in the interest of clarity). Although the HBM 122 is depicted as a single entity in FIG. 1, some embodiments of the HBM 122 (or other memories or caches) are associated with or implemented in the processor cores 120. For example, a level I (L1) cache can be implemented in each of the processor cores 120.

The illustrated embodiment of the parallel processing unit 118 also includes a set of registers 124 such as registers that support advanced vector extensions and advanced computational extensions, as discussed herein. The registers 124 can include one or more scale registers implemented with circuitry that is configured to store scale factors that are associated with input vectors that are provided to operations performed by the parallel processing unit 118. For example, registers that store block scale factors can be partitioned into a first portion that stores a first set of the block scale factors and a second portion that stores the second set of the block scale factors. In some embodiments, the operation is an outer product operation and the registers 124 store a first set of block scale factors associated with a first input vector to the outer product operation and a second set of block scale factors associated with a second input vector to the outer product operation. Elements of the first input vector and the second input vector can represent quantized values of elements of the matrix or tensor represented in a first precision. The quantized values are represented in a second precision that is lower than the first precision.

The parallel processing unit 118 receives user input that indicates the scale factors that are applied to portions (or blocks) of matrices or tensors that provide the two input vectors. User input can be information that is provided by engineers or other people, and the user input indicates that numerical values of the scale factors, or ranges of the scale factors, or other indicators. The parallel processing unit 118 (or one or more processors or cores implemented therein) is configured to perform the operation based on the first input vector, a first scale factor selected from the first set based on the user input, the second input vector, and a second scale factor selected from the second set based on the user input. Embodiments of the parallel processing unit 118 are therefore referred to herein as a matrix engine or implement a matrix engine such as the matrix engine 126.

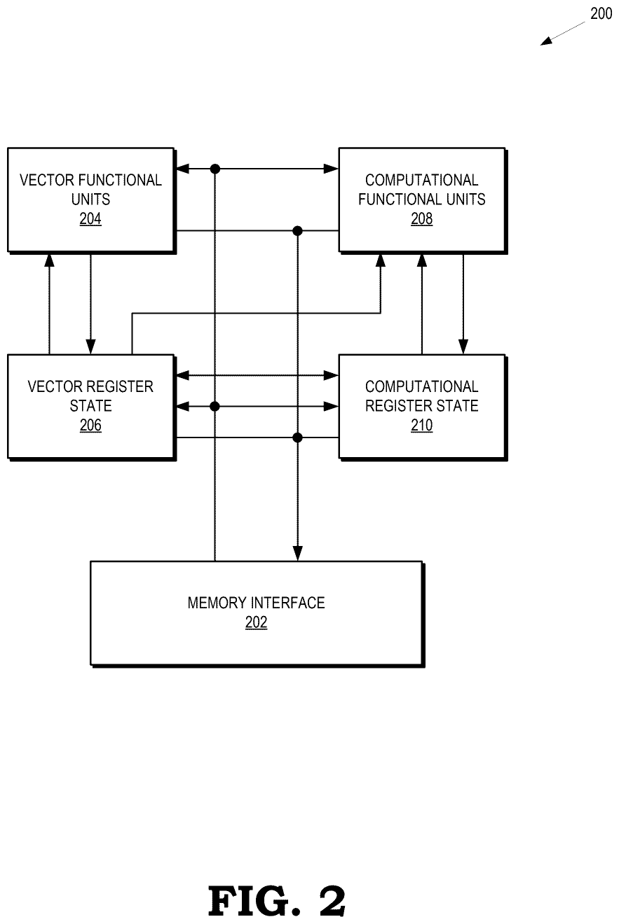

FIG. 2 illustrates a logical organization 200 of computational extensions that support user control of operand scaling, according to some embodiments. The entities represented in the logical organization 200 are implemented in some embodiments of the processing system 100 shown in FIG. 1. The logical organization 200 includes a first portion that supports vector extensions and a second portion that supports computational extensions, both of which interact with a memory interface 202, as discussed herein.

The first portion that supports the vector extensions includes vector functional units 204 that are implemented using circuitry configured to perform vector operations. The first portion also includes vector register state 206 that includes registers implemented using circuitry configured to store state information that can be read, written, or modified by the vector functional units 204. In some embodiments, the vector functional units 204 access one or more of a set of sixteen registers in the vector register state 206 to perform single instructions on multiple pieces of data. The registers in the vector register state 206 can store eight 32-bit single precision floating-point numbers or four 64-bit double precision floating-point numbers, which can be operated on by corresponding operations implemented by the vector functional units 204. The vector functional units 204 can implement a three-operand instruction format that supports a destination register that is distinct from the source operand registers. Operations implemented by the vector functional units 204 can therefore implement a non-destructive three-operand form c←a+b that preserves both source operands.

The second portion that supports the computational extensions includes computational functional units 208 that are implemented using circuitry configured to perform scalar operations. Computational register state 210 includes registers implemented using circuitry configured to store information that can be read, written, or modified by the computational functional units 208. Some embodiments of the computational functional units 208 implement operations to accelerate matrix math operations including outer product operations. The computational register state 210 includes tile and block scale registers, as well as other register state, as discussed herein. The computational functional units 208 support data processing operations that consume register input from the computational register state 210 and operate on tile register state. The computational functional units 208 also support data move operations to move operations between the vector register state 206, the computational register state 210, and a memory via the memory interface 202.

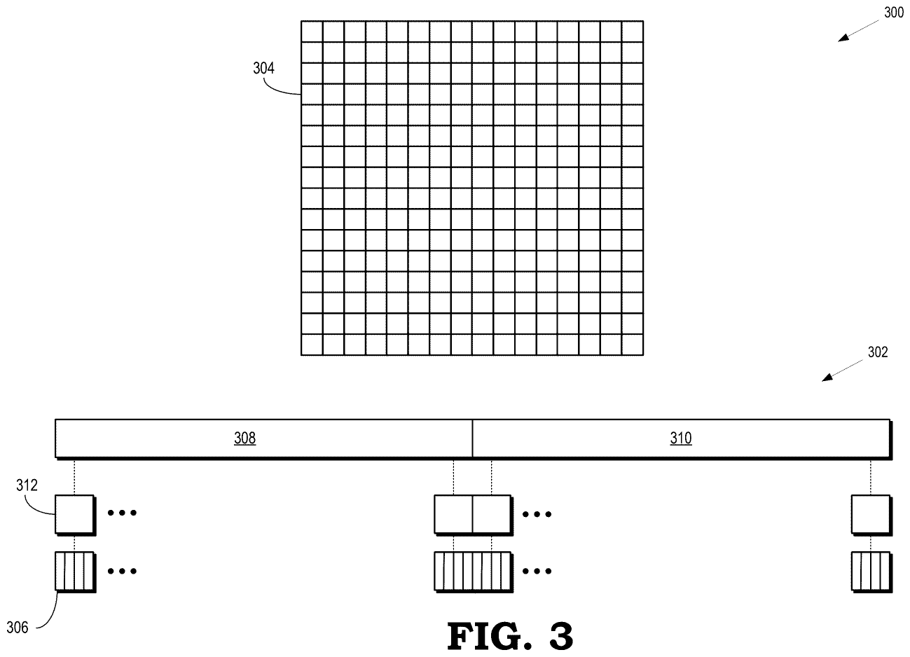

FIG. 3 illustrates a set 300 of tile registers and a corresponding block scale register 302, according to some embodiments. The set 300 and the block scale register 302 can be implemented in the registers 124 shown in FIG. 1 and the computational register state 210 shown in FIG. 2. Groups of tiles 304 (only one indicated by a reference numeral in the interest of clarity) are used to implement the tile registers in the set 300. In some embodiments, the columns of tiles 304 in the set 300 of tile registers each represent a tile register having a dimension of 512 bits by sixteen rows. The dimensions of the tile registers therefore correspond to dimensions of operations implemented using vector functionality, such as the vector functional units 204 shown in FIG. 2. The tile register rows can include a number of elements that depends on the type of data being processed in the tile register such as 32-bit floating-point or integer accumulator types. The number of tile registers implemented in the set 300 depends on the processor architecture and can be discoverable, e.g., using feature registers.

The block scale register 302 includes scale elements 306 (only one indicated by a reference numeral in the interest of clarity) that can be applied to intermediate results prior to accumulation during computation of operations such as the operations supported by the computational functional units 208 shown in FIG. 2. In the illustrated embodiment, the block scale register 302 includes two segments 308, 310 that are dedicated to corresponding inputs to the operations supported by the computational functional units. In some embodiments, the block scale register is 1024 bits wide and the two segments 308, 310 are both 512 bits wide. The segments 308, 310 are composed of four groups of scale elements 306 that are organized by an element index that references subsets 312 (only one indicated by a reference numeral in the interest of clarity) of the scale elements 306. Thus, each subset 312 represented by an element index includes one of the scale elements 306 from each of the groups in the segments 308, 310. In some embodiments, the operations that use the block scale register 302 interpret 8-bit scale elements as an exponent-eight-mantissa-zero (E8M0) power-of-two scale.

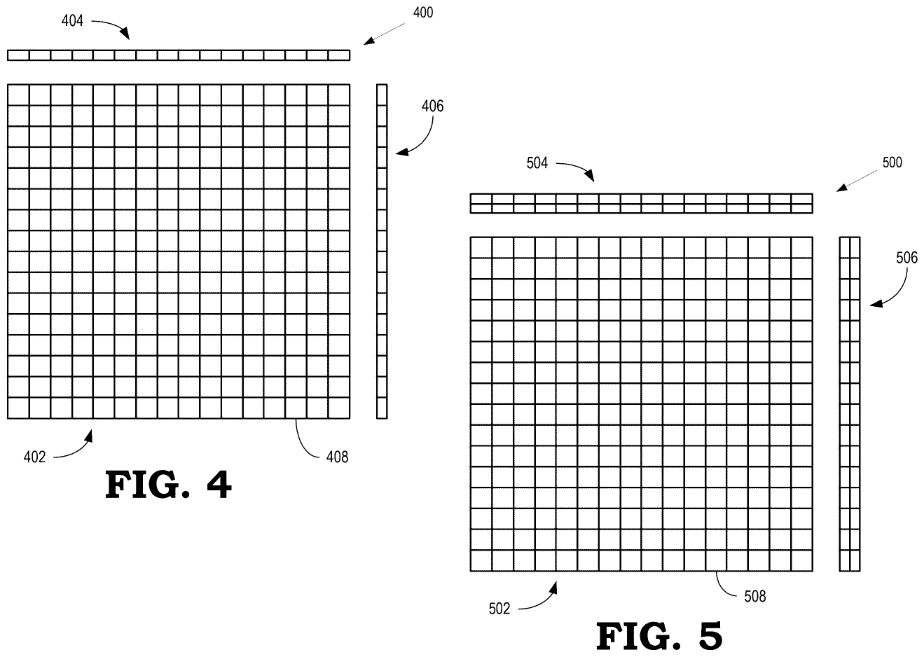

FIG. 4 illustrates an operation 400 that computes a radix-1 outer product 402 of two input vectors 404, 406, according to some embodiments. The operation 400 is implemented in some embodiments of the processing system 100 shown in FIG. 1 and the computational functional units 208 shown in FIG. 2. As used herein, the terms “radix-1” or “rank 1” indicates that elements of the input vectors 404, 406 have a width that is equal to the width of the tile elements or tiles 408 (only one indicated by a reference numeral in the interest of clarity) in the outer product 402. In some embodiments, the elements of the first input vector 404 and the second input vector 406 represent quantized values of elements represented in a first precision. For example, the quantized values can be represented in a second precision that is lower than the first precision.

To determine the values of the tile elements 408 at the intersections of the row and column elements, the row and column elements from the input vectors 404, 406 are multiplied and accumulated with values in the corresponding destination tile element 408. In some embodiments, the outer product is implemented using a general matrix multiplication (GEMM) operation of the form:

$$C = α {A}^{T} B + β C$$

A matrix multiply can be synthesized by applying multiple radix-1 outer products 402. For example, a 16×16 matrix multiplication can be synthesized by applying 16 consecutive rank-1 outer product operations, stepping one row and column through the two input matrices at each iteration.

FIG. 5 illustrates an operation 500 that computes a radix-2 outer product 502 of two input vectors 504, 506, according to some embodiments. The operation 500 is implemented in some embodiments of the processing system 100 shown in FIG. 1 and the computational functional units 208 shown in FIG. 2. As used herein, the terms “radix-2” or “rank 2” indicate that elements of the input vectors 204, 206 have a width that is equal to half of the width of the tile elements 508 (only one indicated by a reference numeral in the interest of clarity) in the outer product 502. Thus, to determine the values of the tile elements 508 at the intersections of the row and column elements, the row and column elements from the input vectors 504, 506 are multiplied and accumulated with values in the corresponding destination tile element 508. This operation is equivalent to performing two iterations of a radix-1 outer product where the input element data is half the size of the destination tile element.

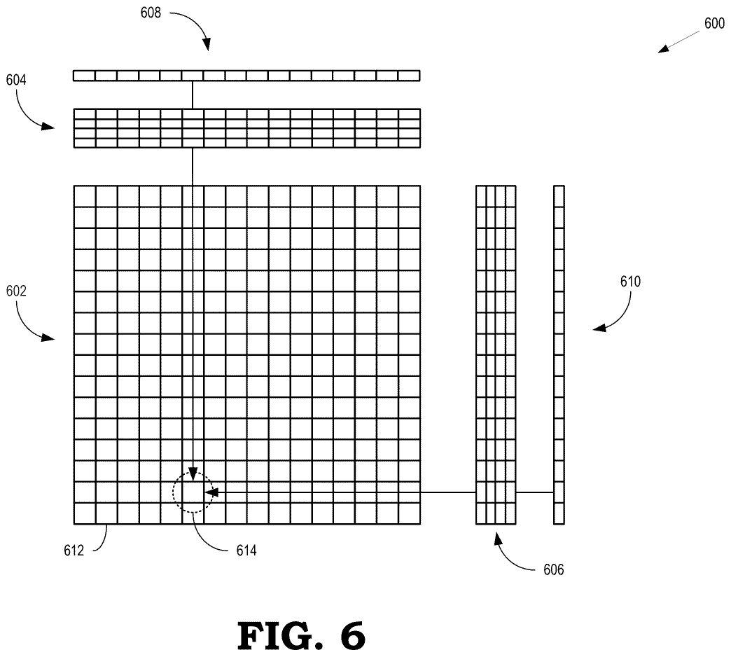

FIG. 6 illustrates an operation 600 that computes a radix-4 outer product 602 of two input vectors 604, 606 that are scaled by corresponding scale factors 608, 610, according to some embodiments. The operation 600 is implemented in some embodiments of the processing system 100 shown in FIG. 1 and the computational functional units 208 shown in FIG. 2. As used herein, the terms “radix-4” or “rank 4” indicate that elements of the input vectors 604, 606 have a width that is equal to one quarter of the width of the tile elements 612 (only one indicated by a reference numeral in the interest of clarity) in the outer product 602. Thus, to determine the values of the tile elements 608 at the intersections 614 of the row and column elements, the row and column elements from the input vectors 604, 606 are multiplied and accumulated with values in the corresponding destination tile element 608. This operation is equivalent to performing four iterations of a radix-1 outer product where the input element data is one quarter the size of the destination tile element.

Scale factors 608, 610 are applied to the input vectors 604, 606, respectively. In the illustrated embodiment, the scale factors 608, 610 are represented in a block scale format that associates a power-of-two scale with each block of element data, e.g., a block of entries or elements in a matrix or tensor that provides the input vectors 604, 606. However, other embodiments can use other scale factor formats that are not constrained to a power-of-two. To generate values in the tile elements 612, corresponding sub-elements are multiplied and summed at the intersection 614 of the row and column elements. The intersecting scale values from the scale factors 608, 610 are combined to form a power-of-two scale that is applied to the product of the sub-elements prior to accumulation with a previous value of a destination tile element 608 at the intersections 614. For example, the scale factors 608, 610 can be represented as exponents that are added to combine the scale factors 608, 610. The sum of the two exponents is then representative of the product of the scale factors 608, 610.

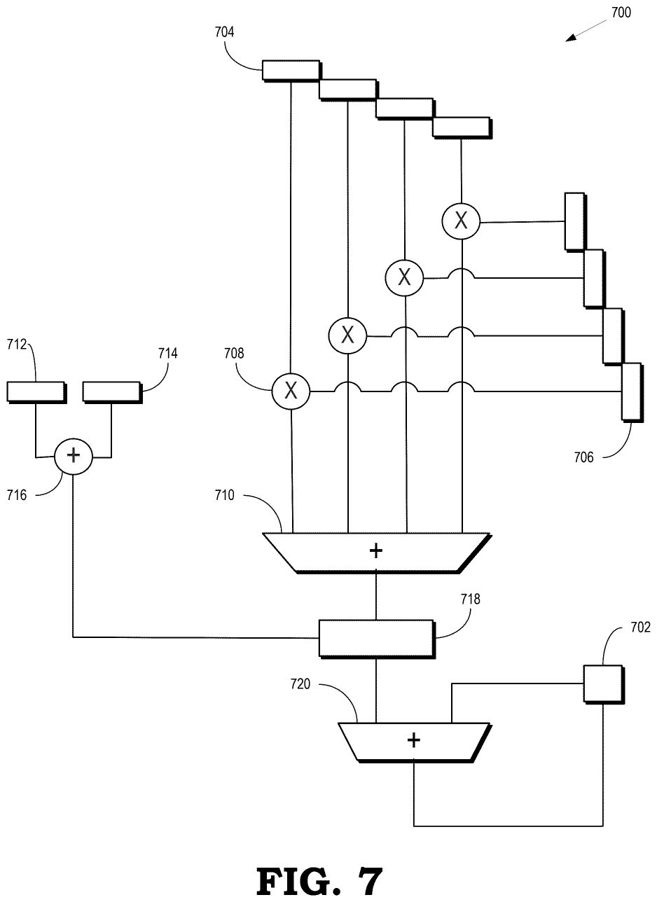

FIG. 7 illustrates circuitry 700 configured to perform an outer product operation on scaled input vectors at a tile element 702, according to some embodiments. In the illustrated embodiment, the tile element 702 corresponds to the tile element at the intersection 614 shown in FIG. 6.

The outer product operation is a radix 4 operation and therefore operates on four portions 704 (only one indicated by a reference numeral in the interest of clarity) of a first input vector read from a corresponding first register and four portions 706 (only one indicated by a reference numeral in the interest of clarity) of a second input vector read from a corresponding second register. The circuitry 700 includes multipliers 708 (only one indicated by a reference numeral in the interest of clarity) that are implemented using circuitry configured to multiply corresponding portions 704, 706 of the first and second input vectors. Results or products of the multiplication operations performed by the multipliers 708 are provided to addition or accumulation circuitry 710 that combines the products of the portions 704, 706. The multipliers 708 can also be referred to as multiplication circuits 708.

Scale factors 712, 714 associated with the first and second input vectors, respectively, are combined by the circuitry 700. The scale factors 712, 714 correspond to some embodiments of elements in the scale factors 608, 610 shown in FIG. 6. In the illustrated embodiment, the scale factors 712, 714 are power-of-two factors that are represented by corresponding exponents and can therefore be added by addition circuitry 716 to form a value (an exponent) that represents a product of the scale factors 712, 714. However, other methods of combining the scale factors 712, 714 to produce information representative of a product of the scale factors 712, 714 can be used in embodiments that are not constrained to power-of-two factors. The information representing the product of the scale factors 712, 714 is provided to scaling circuitry 718 that combines the product of the scale factors 712, 714 with the accumulated product of the portions 704, 706 to generate scaled products, which are then provided to accumulation circuitry 720 and accumulate the scaled products with previously calculated values in the tile element 702.

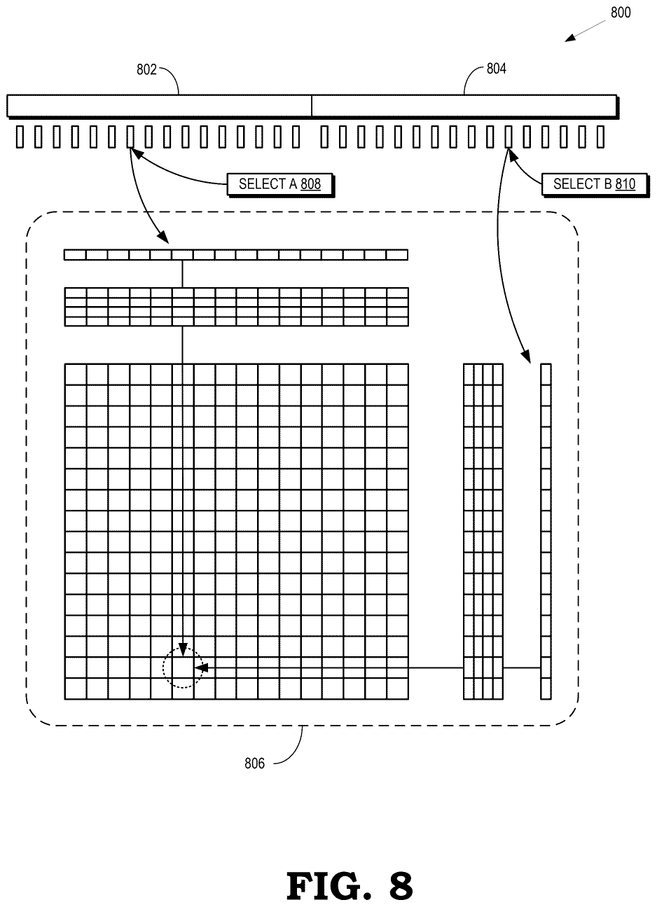

FIG. 8 illustrates a method 800 of user-controlled operand scaling, according to some embodiments. The method 800 is implemented in some embodiments of the processing system 100 shown in FIG. 1. In the illustrated embodiment, a block scale factor register includes a first portion 802 configured to store multiple options of scale factors can be applied to the first input vector and a second portion 804 configured to store multiple options for scale factors that can be applied to a second input vector. The block scale factor register can be implemented using some embodiments of the block scale factor register 302 shown in FIG. 3.

Scale factors selected from the options stored in the first portion 802 and the second portion 804 are used to perform an operation such as the outer product operation 806. For example, the first portion 802 can store a predetermined number (e.g., eight) different values (options) of scale factors that can be applied to the first input vector and the second portion 804 and store a predetermined number (e.g., eight) different values (options) of scale factors that can be applied to the second input vector. Some embodiments of the outer product operation 806 correspond to the radix-4 outer product operation 600 shown in FIG. 6. A user provides an instruction that invokes the operation and includes information that identifies the scale factor options that are to be applied to the input vectors. In the illustrated embodiment, the information identifying the scale factor options includes a first index 808 including information that indicates a selected option for the first input vector (SELECT_A) and a second index 810 including information that indicates a selected option for the second input vector (SELECT_B). The first index 808 indicates, or points to, a scale factor from the first portion 802. For example, the first index 808 can indicate a subset or group of the selected options and an element index of the selected option within the group, as discussed herein. The second index 810 indicates, or points to, a scale factor from the second portion 804. For example, the second index 810 can indicate a subset or group of the selected options and an element index of the selected option within the group, as discussed herein.

The user-selected scale factors are then stored in scale factor registers of the outer product operation 806. For example, the user selected scale factors can be stored in the scale factor registers 608, 610 shown in FIG. 6. A processing unit can then access the scale factors stored in the scale factor registers to perform operations such as the outer product operation 806, as discussed herein. The user can select different sets of scale factors for different blocks by providing different values of the first index 808 or the second index 810 during different iterations of the method 800. The block scale factors stored in the portions 802, 804 can be modified in response to user input, such as a request to load a new set of block scale factors into one or more of the portions 802, 804. Thus, different subsets of scale factors can be utilized in different time intervals. Some embodiments, new sets of block scale factors can be stored in the portions 802, 804 concurrently with performing the outer product operation 806 based on previous sets of block scale factors that were stored, and read from, the portions 802, 804. For example, if first and second sets of block scale factors have been read, written, or copied into the registers of the outer product operation 806, third and fourth sets of block scale factors can be loaded or copied into the portions 802, 804 concurrently with performing the outer product operation 806 based on the first scale factor and the second scale factor. Multiple sets of registers for storing portions of the block scale registers associated with different blocks can also be implemented to support prefetching batches of scale factors.

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified, and all such variations are considered within the scope of the disclosed subject matter. Accordingly, the protection sought herein is as set forth in the claims below.

What is claimed is:

1. An apparatus, comprising:
a scale register configured to store a first set of block scale factors associated with a first input vector to an operation and a second set of block scale factors associated with a second input vector to the operation; and
a processing unit configured to perform the operation based on the first input vector, a first scale factor selected from the first set based on user input, the second input vector, and a second scale factor selected from the second set based on the user input.

2. The apparatus of claim 1, wherein the operation is an outer product of the first input vector and the second input vector, and wherein the processing unit comprises a matrix engine configured to perform the outer product of the first input vector and the second input vector.

3. The apparatus of claim 2, wherein elements of the first input vector and the second input vector represent quantized values of elements represented in a first precision, and wherein the quantized values are represented in a second precision that is lower than the first precision.

4. The apparatus of claim 3, wherein the matrix engine is configured to multiply elements in the first input vector with elements in the second input vector to form a first product, scale the first product by a combination of first scale factor and the second scale factor, and accumulate the scaled first product in a corresponding tile of an outer product matrix.

5. The apparatus of claim 4, wherein the first input vector and the second input vector have a radix that is greater than one, and wherein the matrix engine is configured to accumulate a number of products of elements in the first input vector with elements in the second input vector to form the first product, and wherein the number of products corresponds to the radix.

6. The apparatus of claim 1, wherein the first set of block scale factors comprises information representing a plurality of scale factor options that are associated with corresponding elements in the first input vector and the second input vector.

7. The apparatus of claim 6, wherein the processing unit is configured to select the first scale factor for the elements in the first input vector based on user input indicating a first scale factor option of the plurality of scale factor options associated with the corresponding element, and wherein the processing unit is configured to select the second scale factor for the elements in the second input vector based on user input indicating a second scale factor option of the plurality of scale factor options associated with the corresponding element.

8. The apparatus of claim 1, wherein the first input vector and the second input vector are drawn from a first block of a matrix or tensor, wherein the first block of scale factors and the second block of scale factors are associated with the first block of the matrix or tensor.

9. The apparatus of claim 8, wherein the processing unit is configured to load a third set of block scale factors and a fourth set of block scale factors associated with a second block concurrently with performing the operation based on the first input vector, the first scale factor, the second input vector, and the second scale factor.

10. The apparatus of claim 8, further comprising:
a plurality of scale registers configured to store different sets of block scale factors associated with different blocks of the matrix or tensor.

11. A method, comprising:
performing, at a processing unit, an operation that combines corresponding elements of a first input vector and a second input vector to form a first product; and
scaling, at the processing unit, the first product based on a combination of a first scale factor selected from a first set of block scale factors based on user input and a second scale factor selected from a second scale factor selected from a second set of block scale factors based on the user input a first set of block scale factors and the second set of block scale factors being stored in a scale register.

12. The method of claim 11, wherein the operation is an outer product of the first input vector and the second input vector, and wherein performing the operation comprises multiplying the elements in the first input vector with the elements in the second input vector to form the first product, wherein scaling the first product comprises scaling the first product by a product of first scale factor and the second scale factor.

13. The method of claim 12, further comprising:
accumulating the scaled first product with at least one previous value of the scaled first product in a corresponding tile of an outer product matrix.

14. The method of claim 11, wherein the first set of block scale factors comprises information representing a plurality of scale factor options that are associated with corresponding elements in the first input vector and the second input vector, and further comprising:
selecting the first scale factor for the elements in the first input vector based on user input indicating a first scale factor option of the plurality of scale factor options associated with the corresponding element; and
selecting the second scale factor for the elements in the second input vector based on user input indicating a second scale factor option of the plurality of scale factor options associated with the corresponding element.

15. The method of claim 11, wherein the first input vector and the second input vector are drawn from a first block of a matrix or tensor, wherein the first block of scale factors and the second block of scale factors are associated with the first block of the matrix or tensor, and further comprising:
loading a third set of block scale factors and a fourth set of block scale factors associated with a second block concurrently with performing the operation based on the first input vector, the first scale factor, the second input vector, and the second scale factor.

16. The method of claim 15, further comprising:
loading, in different time intervals, different sets of block scale factors into a plurality of scale registers, the different sets of block scale factors being associated with different blocks of the matrix or tensor.

17. An apparatus, comprising:
a first set of registers configured to store elements of a first vector;
a second set of registers configured to store elements of a second vector;
a scale register configured to store a first set of scale factors associated with the first vector and a second set of scale factors associated with the second vector; and
a matrix engine configured to generate a matrix representing an outer product of the first vector and the second vector based on the first vector, a first scale factor selected from the first set based on user input, the second vector, and a second scale factor selected from the second set based on the user input.

18. The apparatus of claim 17, wherein the matrix engine comprises:
at least one multiplication circuit configured to multiply at least one element of the first vector with at least one element of the second vector to form at least one first product; and
scaling circuitry configured to combine the first scale factor and the second scale factor, and further configured to scale the at least one first product based on the combined first scale factor and second scale factor.

19. The apparatus of claim 18, wherein the first vector and the second vector have a radix greater than one, wherein the first set of registers and the second set of registers are configured to store a number of sub-elements of the elements of the first vector and the second vector, the number corresponding to the radix, the apparatus further comprising:
a plurality of multiplication circuits configured to multiply the sub-elements of the at least one element of the first vector with the sub-elements of the at least one element of the second vector to form a plurality of first products;
first accumulation circuitry to combine the plurality of first products into a second product; and
scaling circuitry configured to combine the first scale factor and the second scale factor, the scaling circuitry being further configured to scale the second product based on the combined first scale factor and second scale factor.

20. The apparatus of claim 19, further comprising:
second accumulation circuitry configured to combine the scaled second product with at least one previously scaled second product in a tile of the matrix associated with the first vector and the second vector.
